(19) United States
(12) Patent Application Publication
(10) Pub. No.: US 2014/0034837 A1
(43) Pub. Date: Feb. 6, 2014

(54) RADIATION IMAGING APPARATUS AND RADIATION IMAGING SYSTEM

(71) Applicant: Canon Kabushiki Kaisha, Tokyo (JP)

(72) Inventors: Shinichi Takeda, Honjo-shi (JP); Masato Inoue, Kumagaya-shi (JP); Satoru Sawada, Fujioka-shi (JP); Takamasa Ishii, Honjo-shi (JP); Taiki Takei, Okegawa-shi (JP); Kota Nishibe, Honjo-shi (JP)

(73) Assignee: CANON KABUSHIKI KAISHA, Tokyo (JP)

(21) Appl. No.: 13/958,253

(22) Filed: Aug. 2, 2013

(30) Foreign Application Priority Data
Aug. 3, 2012 (JP) 2012-173248

(51) Int. Cl. G01T 1/20

(52) U.S. Cl. CPC G01T 1/2006
USPC 250/366

(57) ABSTRACT

A radiation imaging apparatus includes a phosphor layer configured to convert an incident radiant ray into light, a first imaging substrate arranged on a side of a first surface, on which the radiant ray is incident, of the phosphor layer and having, on the side of the first surface, a first pixel area including a plurality of pixels each including a photoelectric conversion element for converting the light into an electric signal, and a second imaging substrate arranged on a side of a second surface of the phosphor layer and having, on the side of the second surface, a second pixel area including a plurality of pixels each including a photoelectric conversion element for converting the light into an electric signal, wherein the second imaging substrate is arranged so that the second pixel area is located opposite a pixel non-formation area, where the first pixel area is not formed.

### BACKGROUND OF THE INVENTION

1. Field of the Invention

The present invention relates to a radiation imaging apparatus for capturing an object using radiation, and a radiation imaging system. Particularly, the present invention is appropriate for use in a medical field.

2. Description of the Related Art

In recent years, digitization has been advanced in various medical fields, and a radiation imaging apparatus having a large area of about a maximum of 40 cm×40 cm has been developed in a field of X-ray diagnosis. In a typical radiation imaging apparatus, a scintillator (a phosphor layer) converts incident radiation into visible light, and a conversion element, such as a photoelectric conversion element, included in each of pixels in a pixel area formed on an imaging substrate converts the visible light into an electric signal. Thus, image data is obtained.

However, as the area of the radiation imaging apparatus increases, the manufacturing yield of the imaging substrate decreases. As a solution thereto, a technique for arranging a plurality of imaging substrates to increase the area of a radiation imaging apparatus has been known, as discussed in Japanese Patent Application Laid-Open No. 2002-48870 and Japanese Patent Application Laid-Open No. 2002-44522. However, it is difficult in manufacturing to clear a gap between an end of the imaging substrate and an end of a pixel area formed on the imaging substrate. Therefore, if the two imaging substrates are horizontally arranged when they are used, for example, an area where a radiation image is not captured (a non-imaging area) is generated in a boundary portion (a joint) between respective pixel areas on the imaging substrates.

In such a case, an image in the non-imaging area can also be generated and complemented based on image information in an area adjacent to the non-imaging area before being output, and displayed as an entire image. If a high-resolution image (e.g., an image having a pixel array of 100 μm or less) is obtained, however, the non-imaging area extends to a plurality of arrays, resulting in a significantly lowered image grade.

If a radiation imaging apparatus is increased in area by horizontally arranging a plurality of imaging substrates, like in the conventional technique, the cutting accuracy and the affixing accuracy of the imaging substrates need to be considered. Therefore, a gap exists between the adjacent imaging substrates. No conversion element exists in the gap. Therefore, image information between the imaging substrates may be unrecognizable. More specifically, the image information between the imaging substrates may be defective.

### SUMMARY OF THE INVENTION

The present invention is directed to a radiation imaging apparatus for preventing image information between imaging substrates from being defective, and a radiation imaging system.

According to an aspect of the present invention, a radiation imaging apparatus includes a phosphor layer configured to convert an incident radiant ray into light, a first imaging substrate arranged on a side of a first surface, on which the radiant ray is incident, of the phosphor layer and having, on the side of the first surface, a first pixel area including a plurality of pixels each including a photoelectric conversion element for converting the light into an electric signal, and a second imaging substrate arranged on a side of a second surface, serving as a rear surface of the first surface, of the phosphor layer and having, on the side of the second surface, a second pixel area including a plurality of pixels each including a photoelectric conversion element for converting the light into an electric signal, wherein the second imaging substrate is arranged so that the second pixel area is located opposite a pixel non-formation area, where the first pixel area of the first imaging substrate is not formed.

According to another aspect of the present invention, a radiation imaging system includes the above-mentioned radiation imaging apparatus, a signal processing unit configured to process the respective electric signals from the first pixel area and the second pixel area, a recording unit configured to record image data obtained in the processing performed by the signal processing unit, a display unit configured to display an image based on the image data, and a transmission unit configured to transmit the image data.

According to exemplary embodiments of the present invention, the image information between the imaging substrates can be prevented from being defective.

Further features of the present invention will become apparent from the following description of exemplary embodiments with reference to the attached drawings.

### BRIEF DESCRIPTION OF THE DRAWINGS

FIG. 1 is a schematic perspective view of a radiation imaging apparatus according to a first exemplary embodiment.

FIG. 2 is a cross-sectional view of the radiation imaging apparatus according to the first exemplary embodiment.

FIG. 3 is a plan view of the radiation imaging apparatus according to the first exemplary embodiment.

FIG. 4 is a cross-sectional view of a radiation imaging apparatus according to a second exemplary embodiment.

FIG. 5 is a plan view of the radiation imaging apparatus according to the second exemplary embodiment.

FIG. 6 is a cross-sectional view of a radiation imaging apparatus according to a third exemplary embodiment.

FIG. 7 is a plan view of the radiation imaging apparatus according to the third exemplary embodiment.

FIG. 8 is a cross-sectional view of a radiation imaging apparatus according to a fourth exemplary embodiment.

FIG. 9 is a plan view of the radiation imaging apparatus according to the fourth exemplary embodiment.

FIG. 10 is a schematic view of an X-ray imaging system (radiation imaging system) according to a fifth exemplary embodiment.

### DESCRIPTION OF THE EMBODIMENTS

Exemplary embodiments of a radiation imaging apparatus and a radiation imaging system according to the present invention will be described below with reference to the drawings. In the exemplary embodiments of the present invention, described below, light includes visible light and an infrared ray, and radiation includes an X-ray, an alpha ray, a beta ray, and a gamma ray.

A radiation imaging apparatus according to a first exemplary embodiment of the present invention will be described below with reference to the drawings.

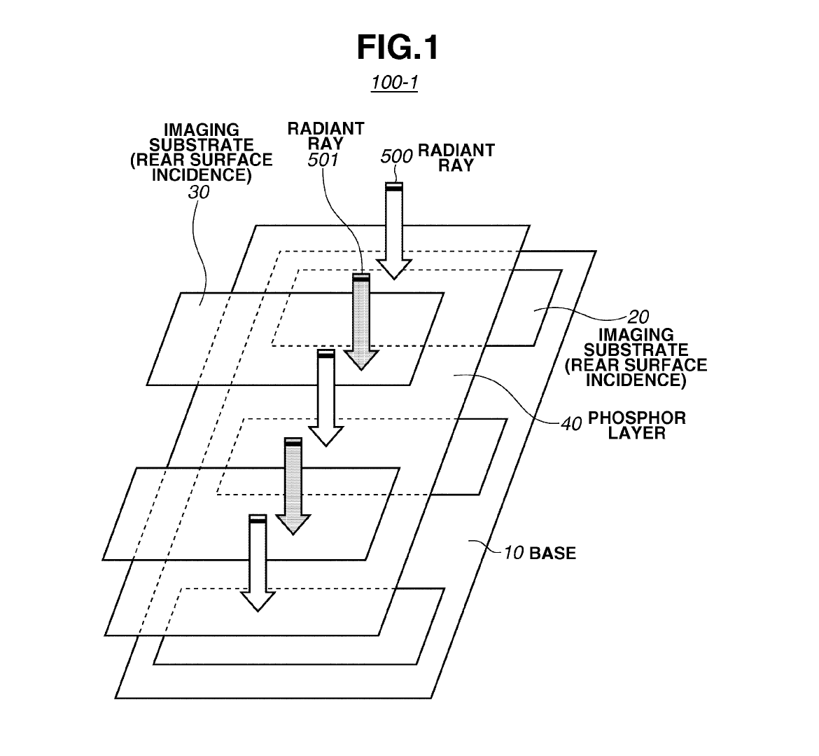

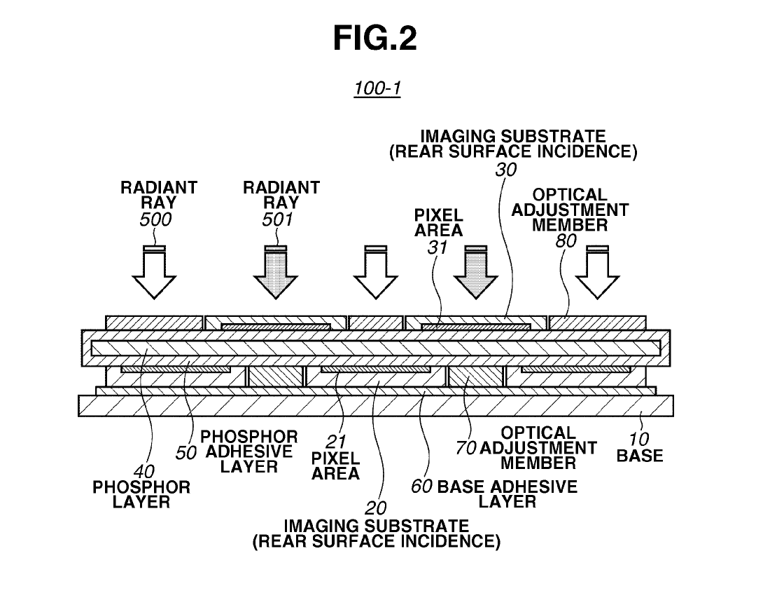

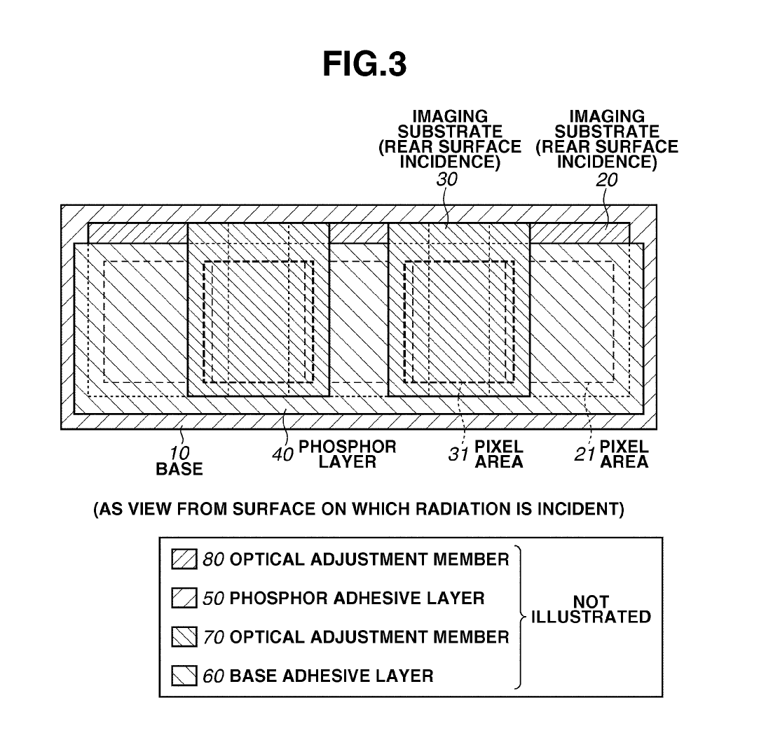

FIG. 1 is a schematic perspective view of a radiation imaging apparatus 100-1 according to the first exemplary embodiment of the present invention. FIG. 2 is a cross-sectional view of the radiation imaging apparatus 100-1 according to the first exemplary embodiment of the present invention. In FIG. 2, the same components as those illustrated in FIG. 1 are assigned the same reference numerals. FIG. 3 is a plan view of the radiation imaging apparatus 100-1 according to the first exemplary embodiment of the present invention. In FIG. 3, the same components as those illustrated in FIG. 2 are assigned the same reference numerals.

An operation principle of the radiation imaging apparatus 100-1 will be first described with reference to FIG. 1.

Radiant rays 500 and 501 exposed toward an object (not illustrated) are attenuated by the object to pass through the object. The radiant ray 500, which has passed through the object, is incident on a phosphor layer 40, and the radiant ray 501, which has passed through the object, is incident on the phosphor layer 40 after passing through a first imaging substrate 30. Each of the radiant rays 500 and 501, which have been incident on the phosphor layer 40, is converted into light. The light is incident on the first imaging substrate 30 having a pixel area 31 formed on its surface on the side of the phosphor layer 40, and a second imaging substrate 20 formed above a base 10. The light, which has been incident on each of the first imaging substrate 30 and the second imaging substrate 20, is converted into a charge serving as an electric signal by a conversion element (a photoelectric conversion element) included in each of pixels in the pixel area formed in the respective imaging substrates 20 and 30. This charge is read out to the outside via a peripheral circuit (not illustrated) by a transfer element included in each of the pixels, to become image data by the subsequent processing. A moving image may also be obtained by repeating the foregoing processing.

A configuration of the radiation imaging apparatus 100-1 will be described below with reference to FIGS. 2 and 3.

The radiation imaging apparatus 100-1 according to the present exemplary embodiment includes the first imaging substrate 30 and an optical adjustment member 80, a phosphor adhesive layer 50, the phosphor layer 40, the phosphor adhesive layer 50, the second imaging substrate 20 and an optical adjustment member 70, a base adhesive layer 60, and the base 10 in this order from the incidence side of the radiant rays 500 and 501, as illustrated in FIG. 2. The radiation imaging apparatus 100-1 is manufactured in an order upward from below in FIG. 2, i.e., in an order directed from the base 10 to the first imaging substrate 30 and the optical adjustment member 80.

The phosphor layer 40 converts each of the incident radiant rays 500 and 501 into light. A surface, on which the radiant rays 500 and 501 are incident, of the phosphor layer 40 is referred to as a “first surface”, and a rear surface of the first surface of the phosphor layer 40 is referred to as a “second surface”.

The first imaging substrate 30 is a first sensor chip, formed of a material that transmits the radiant rays 500 and 501, and is arranged on the side of the first surface of the phosphor layer 40. The first imaging substrate 30 has a first pixel area 31 including a plurality of pixels each including a photoelectric conversion element for converting the light output from the phosphor layer 40 into a charge serving as an electric signal, and formed on its surface on the side of the first surface of the phosphor layer 40 (its surface opposite the phosphor layer 40).

The second imaging substrate 20 is a second sensor chip, and is arranged on the side of the second surface of the phosphor layer 40. The second imaging substrate 20 has a second pixel area 21 including a plurality of pixels each including a photoelectric conversion element for converting the light output from the phosphor layer 40 into a charge serving as an electric signal, and formed on its surface on the side of the second surface of the phosphor layer 40 (its surface opposite the phosphor layer 40). The second pixel area 21 is formed at least at a position opposite a pixel non-formation area where the first pixel area 31 is not formed, as illustrated in FIGS. 2 and 3.

The phosphor adhesive layer 50 is formed to cover the periphery (the entire surface) of the phosphor layer 40, and has functions of protecting the phosphor layer 40 and fixing an arrangement of the phosphor layer 40, the first imaging substrate 30, and the second imaging substrate 20. The phosphor adhesive layer 50 is formed of a transparent adhesive material that transmits the light emitted by the phosphor layer 40. The first imaging substrate 30 and the second imaging substrate 20 are affixed to the phosphor adhesive layer 50, for example, so that the phosphor layer 40, the first imaging substrate 30, and the second imaging substrate 20 constitute an integrated structure with the phosphor adhesive layer 50 interposed therebetween.

In the present exemplary embodiment, the pixels each including the photosensitive conversion element are arranged in a matrix in each of the first pixel area 31 and the second pixel area 21. A complementary metal-oxide semiconductor (CMOS) sensor using crystalline silicon and a p-intrinsic-n (PIN) sensor and a metal-insulator-semiconductor (MIS) sensor using amorphous silicon can be used as the photoelectric conversion element.

As illustrated in FIG. 2, the first pixel area 31 and the second pixel area 21 are respectively formed on the surfaces of the first imaging substrate 30 and the second imaging substrate 20 that oppose the phosphor layer 40. More specifically, the first pixel area 31 and the second pixel area 21 are arranged so that the surface, on which the first pixel area 31 is formed, of the first imaging substrate 30 and the first surface of the phosphor layer 40 oppose each other and the surface, on which the second pixel area 21 is formed, of the second imaging substrate 20 and the second surface of the phosphor layer 40 oppose each other.

The thickness of the first imaging substrate 30 is desirably equal to or less than the thickness of the second imaging substrate 20. In the present exemplary embodiment, the first imaging substrate 30 has a thickness of approximately 100 μm not to prevent the radiant rays 500 and 501 from passing therethrough, and the second imaging substrate 20 has a thickness of approximately 500 μm. Generally, when the thickness of an imaging substrate is large, a radiant ray is prevented from passing therethrough, and light emission from a phosphor layer is reduced, so that light toward pixels is reduced. Generally, the thickness of the imaging substrate is approximately 500 μm. However, the thickness of the first imaging substrate 30 is appropriately 300 μm or less to suppress attenuation of the radiant ray.

At an end of each of the first imaging substrate and the second imaging substrate 20, a pixel non-formation area where no pixels are formed (an area between an end of an external form of the imaging substrate and the pixel area) exists. In the present exemplary embodiment, the pixel area 31 in the first imaging substrate 30 is arranged opposite the pixel non-formation area in the second imaging substrate 20 with the phosphor layer 40 interposed therebetween. The second pixel area 21 in the second imaging substrate 20 is arranged opposite the pixel non-formation area in the first imaging substrate 30 with the phosphor layer 40 interposed therebetween. In the present exemplary embodiment, the first pixel area 31 and the second pixel area 21 are configured opposite and overlap each other (configured to overlap each other in a direction in which the radiant rays 500 and 501 are incident). The first pixel area 31 and the second pixel area 21 are thus configured so that the arrangement accuracy of the first imaging substrate 30 and the second imaging substrate 20 can be reduced.

In an overlap portion where respective images in the imaging substrates overlap each other, an image signal obtained by capturing a basic chart is read after completion of the radiation imaging apparatus, the overlap portion between the images in the imaging substrates, which have been read based on basic image data, is detected, and coordinate data in a joint portion are collected from detected information. Then, image signals, which have been sent to a signal processing unit, are processed into one image based on the coordinate data in the joint portion, to obtain one radiation image.

The optical adjustment member 80 is provided in an imaging substrate non-formation area, for example, between a plurality of first imaging substrates 30, and includes a light reflective material for reflecting light from the phosphor layer 40 or a light absorptive material for absorbing the light. The optical adjustment member 80 has a function of reflecting or absorbing light that has been emitted by the phosphor layer 40 and has been unreceivable by the pixels formed on the first pixel area 31 in the first imaging substrate 30, so that the optical adjustment member 80 adjusts characteristics of sensitivity and resolution of the radiation imaging apparatus 100-1. A light reflective material having light reflectivity, such as an aluminum (Al) sheet, is used as the optical adjustment member 80, for example, to return the light to the pixels formed on the first pixel area 31 in the first imaging substrate 30, so that a highly sensitive image for increasing light output of the first imaging substrate 30 can be obtained. A light absorptive material having light absorptivity, such as a black resin sheet, is used as the optical adjustment member 80, for example, to absorb and eliminate light having a scattering property, so that a high-resolution image can be obtained without stray light to be incident on the pixels formed in the first pixel area 31 in the first imaging substrate 30.

The optical adjustment member 70 is provided in an imaging substrate non-formation area between a plurality of second imaging substrates 20, and includes a light reflective material for reflecting light from the phosphor layer 40 or a light absorptive material for absorbing the light. The optical adjustment member 70 also has a similar function to that of the optical adjustment member 80.

More specifically, in the radiation imaging apparatus 100-1 according to the present exemplary embodiment, the optical adjustment members 70 and 80 are provided in the imaging substrate non-formation area where one of the first imaging substrate 30 and the second imaging substrate 20 does not oppose the other imaging substrate.

In the present exemplary embodiment, an arrangement pitch of the pixels in each of the first pixel area 31 and the second pixel area 21 is 100 μm or less to make the resolution of the image high. In breast diagnosis, for example, a smaller lesion needs to be diagnosed. Therefore, a high-definition diagnostic image is desired. Therefore, the size of the pixels is generally 100 μm or less, and is more desirably 50 μm.

Generally, an area of several ten micrometers to several hundred micrometers is required around an external form of an imaging substrate for a process margin for forming a photoelectric conversion element and a transfer element included in each of pixels, and for a positional accuracy and chipping in cutting the imaging substrate into a desired size. Imaging substrates are also arranged so that a gap of at least several ten micrometers is provided therebetween. If the imaging substrates are thus arranged on the same plane, an area of approximately 100 micrometers where no pixel can be formed is generated between pixels in the imaging substrates.

Even if the size of the pixels formed in each of the imaging substrates can thus be reduced, there is a limit to reduction in a gap between the imaging substrates and a spacing between the pixels in the imaging substrate. Therefore, in the radiation imaging apparatus 100-1 according to the present exemplary embodiment, the first imaging substrate 30 and the second imaging substrate 20 are arranged opposite each other with the phosphor layer 40 sandwiched therebetween, and are arranged so that the imaging substrates provided on the same plane are not proximate each other. Therefore, in the present exemplary embodiment, the pixels at not only an edge but also an end of the imaging substrate can be arranged at a pitch of the pixels formed in the imaging substrate. Further, the imaging substrates may also be overlapped. Therefore, a low-cost radiation imaging apparatus may be manufactured using a low-cost apparatus without requiring high-accuracy positioning.

The base 10 is provided on the surface, on the side opposite the side on which the phosphor layer 40 is formed, of the second imaging substrate 20, as illustrated in FIG. 2.

The base adhesive layer 60 is interposed between the second imaging substrate 20 and the base 10, and is an adhesive layer for fixing the second imaging substrate 20 and the base 10. In the present exemplary embodiment, a damper sheet obtained by forming an adhesive material of several micrometers to several ten micrometers on both surfaces of a sponge-like foamed sheet having a thickness of several ten micrometers to several hundred micrometers is used as a material for the base adhesive layer 60. Even if the height (the thickness of the second imaging substrate 20) of the surface, on which the second pixel area 21 is formed, of the second imaging substrate 20, which is affixed to the base 10 with the base adhesive layer 60 interposed therebetween, is non-uniform, when the phosphor layer 40 is then affixed on the second imaging substrate 20, the base adhesive layer 60 under the second imaging substrate 20 having a large height (large thickness) is elastically compressed, so that the surface of the second imaging substrate 20 having a small height (small thickness) can be pressed. More specifically, the base adhesive layer 60 has a function of making surfaces, on the side on which the phosphor layer 40 is formed, of the plurality of second imaging substrates 20 substantially flat. The base adhesive layer 60 enables respective entire surfaces of the second imaging substrate 20 and the phosphor layer 40 to closely adhere to each other with the phosphor adhesive layer 50 interposed therebetween. Therefore, a radiation imaging apparatus having a uniform resolution is obtained as the radiation imaging apparatus 100-1. The base adhesive layer 60 may also use an adhesive material, e.g., silicon resin having elasticity after curing.

According to the present exemplary embodiment, the second pixel area is formed at least at a position opposite the pixel non-formation area where the first pixel area is not formed. Therefore, the image information can be prevented from being defective.

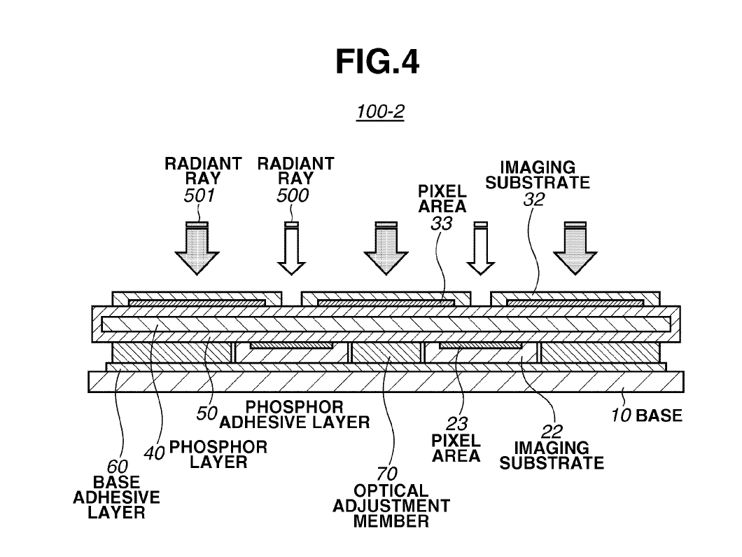

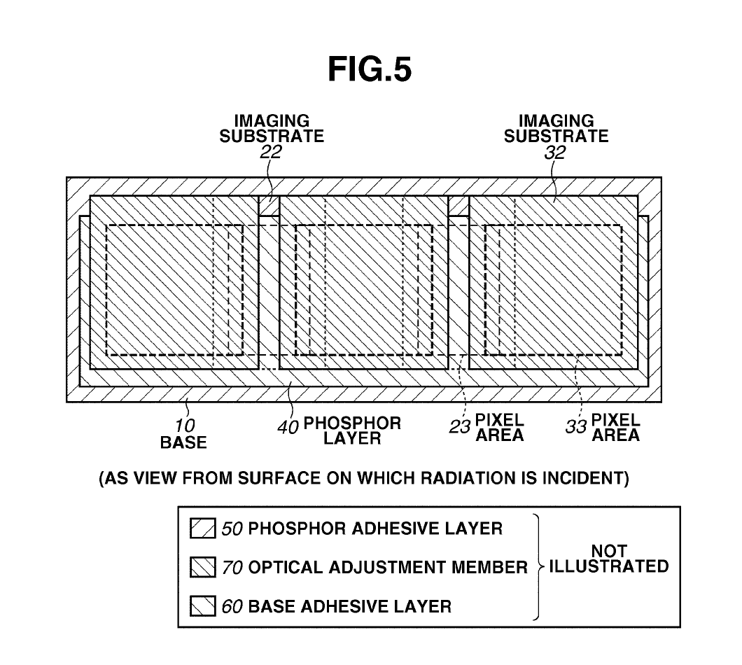

A radiation imaging apparatus according to a second exemplary embodiment of the present invention will be described below with reference to the drawings. FIG. 4 is a cross-sectional view of a radiation imaging apparatus 100-2 according to the second exemplary embodiment of the present invention. In FIG. 4, similar components to those in the radiation imaging apparatus 100-1 according to the first exemplary embodiment illustrated in FIG. 2 are assigned the same reference numerals, and hence description thereof is not repeated. FIG. 5 is a plan view of the radiation imaging apparatus 100-2 according to the second exemplary embodiment of the present invention. In FIG. 5, similar components to those illustrated in FIG. 4 are assigned the same reference numerals. An operation principle of the radiation imaging apparatus 100-2 according to the present exemplary embodiment is similar to the operation principle of the radiation imaging apparatus 100-1 according to the first exemplary embodiment, and hence description thereof is not repeated.

A first imaging substrate 32 is formed of a material that transmits radiant rays 500 and 501, and is arranged on the side of a first surface of a phosphor layer 40. The first imaging substrate 32 has a first pixel area 33 including a plurality of pixels each including a photoelectric conversion element for converting light output from the phosphor layer 40 into a charge serving as an electric signal, and formed on its surface on the side of the first surface of the phosphor layer 40 (its surface opposite the phosphor layer 40). Functions of the first imaging substrate 32 and the first pixel area 33 are respectively similar to the functions of the first imaging substrate 30 and the first pixel area 31 in the first exemplary embodiment. In the radiation imaging apparatus 100-2 according to the present exemplary embodiment, an optical adjustment member 80 is not provided between first imaging substrates 32.

A second imaging substrate 22 is arranged on the side of a second surface of the phosphor layer 40. The second imaging substrate 22 has a second pixel area 23 including a plurality of pixels each including a photoelectric conversion element for converting the light output from the phosphor layer 40 into a charge serving as an electric signal, and formed on its surface on the side of the second surface of the phosphor layer 40 (its surface opposite the phosphor layer 40). Functions of the second imaging substrate 22 and the second pixel area 23 are respectively similar to the functions of the second imaging substrate 20 and the second pixel area 21 in the first exemplary embodiment. The second pixel area 23 is formed at least at a position opposite a pixel non-formation area where the first pixel area 33 is not formed, as illustrated in FIGS. 4 and 5, like in the first exemplary embodiment.

In the radiation imaging apparatus 100-2 according to the present exemplary embodiment, the first imaging substrate 32 is arranged closer to an end area of a base 10 than the second imaging substrate 22 in a direction in which the radiant rays 500 and 501 are incident. Thus, the first imaging substrate 32 can be positioned in an area of interest at the time of image diagnosis of a breast, for example.

In the first imaging substrate 32, the first pixel area 33 is positioned on the side of the first surface of the phosphor layer 40 (i.e., a surface on which radiation is incident). Therefore, light can be received near a light emission center (the surface on which radiation is incident (the first surface)), at which the radiant rays 500 and 501 are converted into light, in the phosphor layer 40, the emitted light can be efficiently received, and light including little scattering light can be received. Thus, a high-power, high-resolution, and highly sharp image can be obtained.

A lesion of breast cancer develops commonly on the chest side. Therefore, there is an area of interest on the chest side in mammography diagnosis. In the radiation imaging apparatus 100-2 according to the present exemplary embodiment, the first imaging substrate 32 is arranged in the end area of the base 10, so that the first imaging substrate 32 can be arranged on the side of an object's chest. Particularly, an image in the area of interest can be obtained at a high grade.

In first imaging substrates 32 arranged on the same plane in the present exemplary embodiment are arranged as proximately as possible one another, and the second pixel area 23 in the second imaging substrate 22 is arranged under an area where the first pixel area 33 does not exist and between the first imaging substrates 32. More specifically, the first imaging substrate 32 and the second imaging substrate 22 differ in size. The first imaging substrate 32 and the second imaging substrate 22 are thus configured, so that a high-power, high-resolution, and highly sharp image signal can be obtained in almost all areas of the image. Thus, the image can be obtained at a high grade.

The size of the pixel area 23 in the second imaging substrate 22 may be at least the size or more of an area where the first pixel area 33 of the first imaging substrate 32 is not formed. The second pixel area 23 in the second imaging substrate 22 may be made large so that the pixel area 33 in the first imaging substrate 32 and the pixel area 23 in the second imaging substrate 22 overlap each other depending on a variation between the first imaging substrates 32 and a positional accuracy of arranging the second imaging substrate 22.

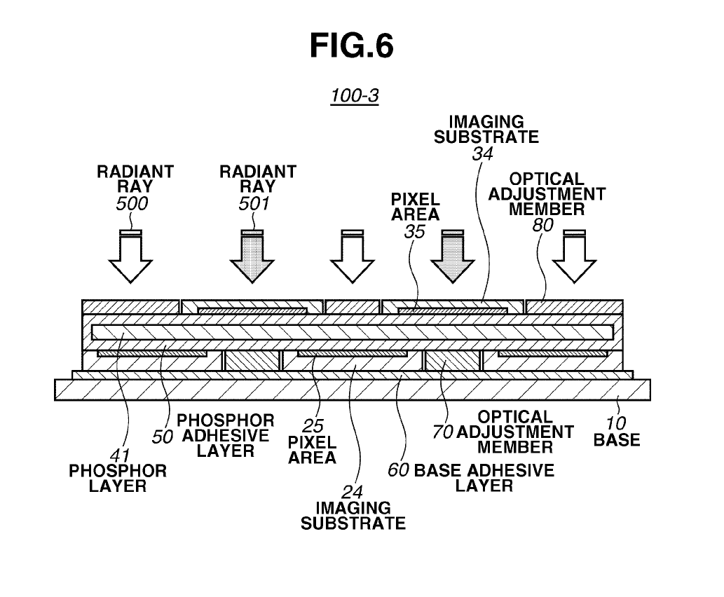

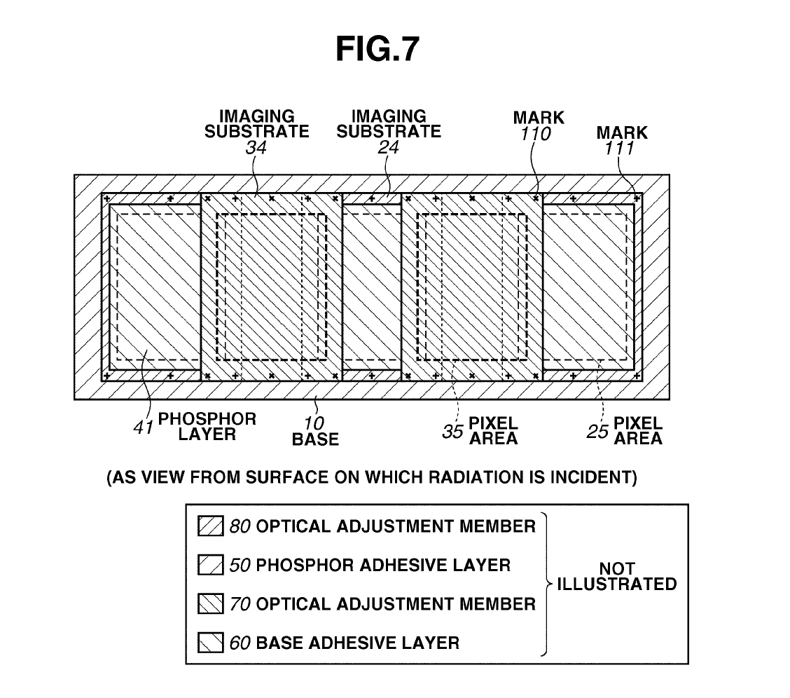

A radiation imaging apparatus according to a third exemplary embodiment of the present invention will be described below with reference to the drawings. FIG. 6 is a cross-sectional view of a radiation imaging apparatus 100-3 according to the third exemplary embodiment of the present invention. In FIG. 6, similar components to those in the radiation imaging apparatus 100-1 according to the first exemplary embodiment illustrated in FIG. 2 and the radiation imaging apparatus 100-2 according to the second exemplary embodiment illustrated in FIG. 4 are assigned the same reference numerals, and hence description thereof is not repeated. FIG. 7 is a plan view of the radiation imaging apparatus 100-3 according to the third exemplary embodiment of the present invention. In FIG. 7, similar components to those illustrated in FIG. 6 are assigned the same reference numerals. An operation principle of the radiation imaging apparatus 100-3 according to the present exemplary embodiment is similar to the operation principle of the radiation imaging apparatus 100-1 according to the first exemplary embodiment, and hence description thereof is not repeated.

A phosphor layer 41 converts each of incident radiant rays 500 and 501 into light. A surface, on which the radiant rays 500 and 501 are incident, of the phosphor layer 41 is referred to as a “first surface”, and a rear surface of the first surface of the phosphor layer 41 is referred to as a “second surface”.

A first imaging surface 34 is formed of a material that transmits the radiant rays 500 and 501, and is arranged on the side of the first surface of the phosphor layer 41. The first imaging substrate 34 has a first pixel area 35 including a plurality of pixels each including a photoelectric conversion element for converting light output from the phosphor layer 41 into a charge serving as an electric signal, and formed on its surface on the side of the first surface of the phosphor layer 41 (its surface opposite the phosphor layer 41). Functions of the first imaging substrate 34 and the first pixel area 35 are respectively similar to the functions of the first imaging substrate 30 and the first pixel area 31 in the first exemplary embodiment.

A second imaging substrate 24 is arranged on the side of the second surface of the phosphor layer 41. The second imaging substrate 24 has a second pixel area 25 including a plurality of pixels each including a photoelectric conversion element for converting the light output from the phosphor layer 41 into a charge serving as an electric signal, and formed on its surface on the side of the second surface of the phosphor layer 41 (its surface opposite the phosphor layer 41). Functions of the second imaging substrate 24 and the second pixel area 25 are respectively similar to the functions of the second imaging substrate 20 and the first pixel area 21 in the first exemplary embodiment. The second pixel area 25 is formed at least at a position opposite a pixel non-formation area where the first pixel area 35 is not formed, as illustrated in FIGS. 6 and 7, like in the first exemplary embodiment.

In the radiation imaging apparatus 100-3 according to the present exemplary embodiment, a mark 110 for adjusting (aligning) an arrangement position (an affixing position) of the first imaging substrates 34 is formed in the pixel non-formation area, where the first pixel area 35 is not formed, of the first imaging substrate 34, as illustrated in FIG. 7. Similarly, as illustrated in FIG. 7, a mark 111 for adjusting (aligning) an arrangement position (an affixing position) of the second imaging substrates 24 is formed in a pixel non-formation area, where the second pixel area 25 is not formed, of the second imaging substrate 24, as illustrated in FIG. 7. The marks 110 and 111 are formed by a pattern of metal (e.g., Al) on an uppermost layer of each of the imaging substrates 34 and 24 (e.g., a formation surface of the pixel area).

When the phosphor layer 41 is affixed on the second imaging substrate 24, the phosphor layer 41 is arranged at a position not covering the mark 111 on the second imaging substrate 24. Then, the first imaging substrate 34 is aligned using the mark 110 formed thereon based on the mark 111 on the second imaging substrate 24, and is affixed on the phosphor layer 41.

In the radiation imaging apparatus 100-3 according to the present exemplary embodiment, the mark with high accuracy can be formed on each of the first and second imaging substrates 34 and 24. The first imaging substrate 34 can be affixed on the phosphor layer 41 while the mark 111 on the second imaging substrate 24 is observed without being hidden. Thus, the first imaging substrate 34 and the second imaging substrate 24 can be arranged with high accuracy. Each of the marks is formed in the pixel non-formation area. Therefore, the pixels in each of the pixel areas are not crushed by the corresponding mark. Further, the size of each of the marks can be further increased. In the present exemplary embodiment, marks in the form of a cross drawn with a line having a width of 100 μm and having a length of 300 μm are formed on each of the imaging substrates 34 and 24.

Thus, mark recognition can be performed with a high-accuracy large mark. Therefore, a visual field of a mark recognition camera of the apparatus can be made wide, a high-accuracy mechanism, such as a positioning mechanism or a high-accuracy conveyance mechanism for putting the mark in the visual field of the camera, of the apparatus is not required. A general-purpose low-cost apparatus can be provided a high-accuracy imaging substrate.

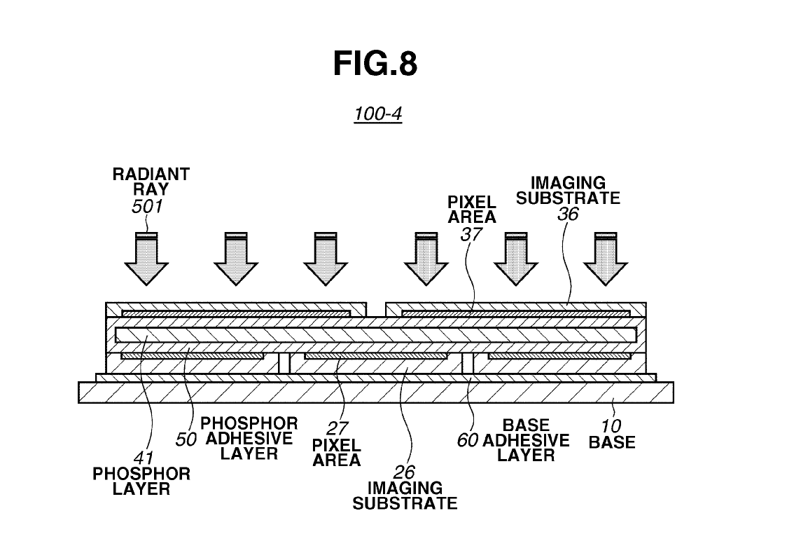

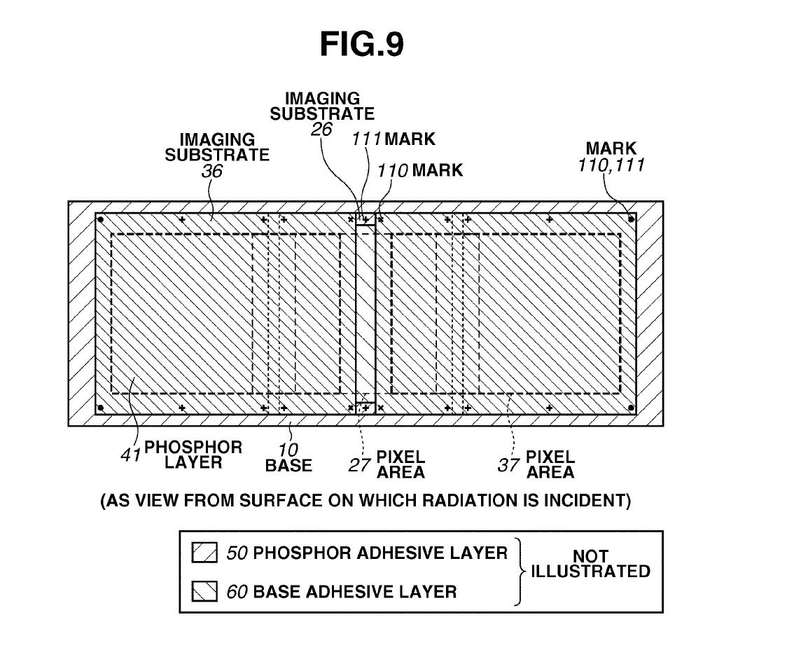

A radiation imaging apparatus according to a fourth exemplary embodiment of the present invention will be described below with reference to the drawings. FIG. 8 is a cross-sectional view of a radiation imaging apparatus 100-4 according to the fourth exemplary embodiment of the present invention. In FIG. 8, similar components to those in the radiation imaging apparatuses 100-1 to 100-3 according to the first to third exemplary embodiments illustrated in FIGS. 2, 4, and 6 are assigned the same reference numerals, and hence description thereof is not repeated. FIG. 9 is a plan view of the radiation imaging apparatus 100-4 according to the fourth exemplary embodiment of the present invention. In FIG. 9, similar components to those illustrated in FIG. 8 are assigned the same reference numerals. An operation principle of the radiation imaging apparatus 100-4 according to the present exemplary embodiment is similar to the operation principle of the radiation imaging apparatus 100-1 according to the first exemplary embodiment, and hence description thereof is not repeated.

A first imaging surface 36 is formed of a material that transmits a radiant ray 501, and is arranged on the side of a first surface of a phosphor layer 41. The first imaging substrate 36 has a first pixel area 37 including a plurality of pixels each including a photoelectric conversion element for converting light output from the phosphor layer 41 into a charge serving as an electric signal, and formed on its surface on the side of the first surface of the phosphor layer 41 (its surface opposite the phosphor layer 41). Functions of the first imaging substrate 36 and the first pixel area 37 are respectively similar to the functions of the first imaging substrate 30 and the first pixel area 31 in the first exemplary embodiment. In the radiation imaging apparatus 100-4 according to the present exemplary embodiment, an optical adjustment member 80 is not provided between first imaging substrates 36.

A second imaging substrate 26 is arranged on the side of a second surface of the phosphor layer 41. The second imaging substrate 26 has a second pixel area 27 including a plurality of pixels each including a photoelectric conversion element for converting the light output from the phosphor layer 41 into a charge serving as an electric signal formed on its surface on the side of the second surface of the phosphor layer 41 (its surface opposite the phosphor layer 41). Functions of the second imaging substrate 26 and the second pixel area 27 are respectively similar to the functions of the second imaging substrate 20 and the first pixel area 21 in the first exemplary embodiment. In the radiation imaging apparatus 100-4 according to the present exemplary embodiment, an optical adjustment member 70 is not provided between second imaging substrates 26. The second pixel area 27 is formed at least at a position opposite a pixel non-formation area where the first pixel area 37 is not formed, as illustrated in FIGS. 8 and 9, like in the first exemplary embodiment.

In the radiation imaging apparatus 100-4 according to the present exemplary embodiment, the first imaging substrates 36 arranged on the same plane are arranged proximately one another, and the second imaging substrates 26 arranged on the same plane are similarly arranged proximately one another. Thus, almost all parts of the first pixel area 37 in the first imaging substrate 36 and almost all parts of the second pixel area 27 in the second imaging substrate 26 are arranged to overlap each other in a direction in which the radiant ray 501 is incident.

In the present exemplary embodiment, image information at the same position is obtained by the first imaging substrate 36 and the second imaging substrate 26 Respective image signals read by both of the imaging substrates 36 and 26 are added, so that a high-resolution and highly sensitive image can be obtained.

Marks 110 and 111, described in the third exemplary embodiment, are respectively formed in the first imaging substrate 36 and the second imaging substrate 26. Respective affixing positions of the imaging substrates 36 and 26 on the same plane, and respective positions of the first and second imaging substrates 36 and 26 can be arranged with high accuracy. Thus, a radiation imaging apparatus capable of obtaining a high-quality and high-grade image can be manufactured.

A fifth exemplary embodiment of the present invention will be described below with reference to the drawings.

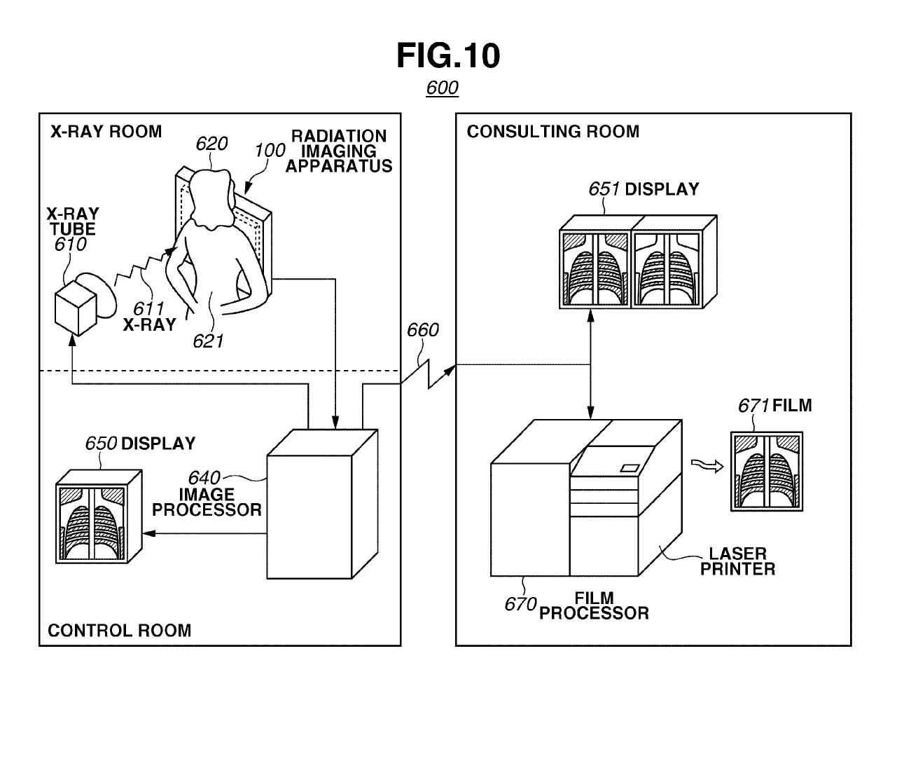

In the fifth exemplary embodiment, a radiation imaging apparatus 100 according to the above-described first to fourth exemplary embodiments is applied to an X-ray imaging system (a radiation imaging system). FIG. 10 is a schematic view of an X-ray imaging system (radiation imaging system) 600 according to the fifth exemplary embodiment of the present invention.

The X-ray imaging system 600 includes the radiation imaging apparatus 100, an X-ray tube 610, an image processor 640, displays 650 and 651, a communication line 660, a film processor 670, and a film 671, as illustrated in FIG. 10.

As illustrated in FIG. 10, an X-ray 611 generated by the X-ray tube 610 serving as a radiation generation unit passes through a chest 621 of an object 620 such as a patient, and is incident on the radiation imaging apparatus 100. The incident X-ray 611 includes information about the inside of the body of the object 620. In the radiation imaging apparatus 100, a phosphor layer emits light in response to the incidence of the X-ray 611, and the light is photoelectrically converted by a photoelectric conversion element included in each of pixels, to generate an electric signal (image signal). The electric signal is converted into a digital signal, and the digital signal is subjected to image processing by the image processor 640 serving as a signal processing unit, to become image data. An image based on the image data is displayed on the display 650 serving as a display unit in a control room (control chamber), so that the inside of the body of the object 620 can be observed. The image data obtained in the image processing by the image processor 640 can be transmitted to a remote place via the communication line 660 serving as a transmission unit from the image processor 640. The image data is transmitted to a consulting room in another place, for example, and the image based on the image data is displayed on the display 651 serving as a display unit, or is stored in a recording unit such as an optical disk, so that a doctor at the remote place can also make a diagnosis. Alternatively, the film processor 670 serving as a recording unit may record the image on the film 671 serving as a recording medium.

The above exemplary embodiments of the present invention merely illustrates an example of concretion in carrying out the present invention, and the technical scope of the exemplary embodiments of the present invention should not be construed restrictively thereby. That is, the exemplary embodiments of the present invention can be embodied in various forms without departing from the technical idea or its main features.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-173248 filed Aug. 3, 2012, which is hereby incorporated by reference herein in its entirety.

What is claimed is:

1. A radiation imaging apparatus comprising:
a phosphor layer configured to convert an incident radiant ray into light;
a first imaging substrate arranged on a side of a first surface, on which the radiant ray is incident, of the phosphor layer and having, on the side of the first surface, a first pixel area including a plurality of pixels each including a photoelectric conversion element for converting the light into an electric signal; and
a second imaging substrate arranged on a side of a second surface, serving as a rear surface of the first surface, of the phosphor layer and having, on the side of the second surface, a second pixel area including a plurality of pixels each including a photoelectric conversion element for converting the light into an electric signal,
wherein the second imaging substrate is arranged so that the second pixel area is located opposite a pixel non-formation area, where the first pixel area of the first imaging substrate is not formed.

2. The radiation imaging apparatus according to claim 1, wherein at least one of the first imaging substrate and the second imaging substrate includes a plurality of imaging substrates.

3. The radiation imaging apparatus according to claim 1, wherein a thickness of the first imaging substrate is equal to or less than a thickness of the second imaging substrate.

4. The radiation imaging apparatus according to claim 1, wherein the thickness of the first imaging substrate is 300 μm or less.

5. The radiation imaging apparatus according to claim 1, further comprising an optical adjustment member including one of a light reflective material and a light absorptive material that is provided in an imaging substrate non-formation area where one of the first imaging substrate and the second imaging substrate is not formed opposite the other imaging substrate.

6. The radiation imaging apparatus according to claim 1, further comprising a transparent phosphor adhesive layer that covers an entire surface of the phosphor layer,
wherein the phosphor layer and the first and second imaging substrates constitute an integrated structure with the phosphor adhesive layer interposed therebetween.

7. The radiation imaging apparatus according to claim 1, wherein an arrangement pitch of the pixels is 100 μm or less in each of the first pixel area and the second pixel area.

8. The radiation imaging apparatus according to claim 1, wherein the second imaging substrate includes a plurality of imaging substrates, and further comprising
a base provided on a surface of the second imaging substrate on a side opposite a side on which the phosphor layer is formed, and
a base adhesive layer interposed between the second imaging substrate and the base and configured to substantially flat surfaces of the plurality of imaging substrates constituting the second imaging substrate on the side on which the phosphor layer is formed.

9. The radiation imaging apparatus according to claim 8, wherein the first imaging substrate is arranged closer to an end area of the base than the second imaging substrate in a direction in which the radiant ray is incident.

10. The radiation imaging apparatus according to claim 1, wherein marks for adjusting arrangement positions of the first imaging substrate and the second imaging substrate are respectively formed in a pixel non-formation area, where the first pixel area is not formed, of the first imaging substrate and a pixel non-formation area, where the second pixel area is not formed, of the second imaging substrate.

11. A radiation imaging system comprising:
the radiation imaging apparatus according to claim 1;
a signal processing unit configured to process the respective electric signals from the first pixel area and the second pixel area;
a recording unit configured to record image data obtained in the processing performed by the signal processing unit;
a display unit configured to display an image based on the image data; and
a transmission unit configured to transmit the image data.
